(19) United States
(12) Patent Application Publication
(10) Pub. No.: US 2008/0301023 A1
(43) Pub. Date: Dec. 4, 2008

(54) Multi-Channel and Cross-Channel Account Opening

(75) Inventors: Amit R. Patel, Woodbridge, NJ (US); Girish Narang, Mineola, NY (US); John S. Darby, Brooklyn, NY (US)

Correspondence Address: COURTNEY STANIFORD & GREGORY LLP, P.O. BOX 9686, SAN JOSE, CA, 95157, US

(73) Assignee: CASHEDGE, INC., New York, NY (US)

(21) Appl. No.: 12/114,565

(22) Filed: May 2, 2008

Related U.S. Application Data
(60) Provisional application No. 60/927,423, filed on May 2, 2007.
(60) Provisional application No. 60/927,618, filed on May 4, 2007.
(60) Provisional application No. 60/937,748, filed on Jun. 28, 2007.

(51) Int. Cl. G06Q 40/00

(52) U.S. Cl. 705/35

(57) ABSTRACT

Embodiments as described herein include methods and a system for multi-channel and cross-channel account opening. An applicant may start an account opening process in one channel and move to one or more other channels without any application data being lost. A financial management system (FMS) provides a single account opening platform for multiple financial institutions (FIs) such that an application to open an account is handled by the FMS platform using shared resources among channels, and applying rules specified by each FI.

### RELATED APPLICATIONS

This application claims the benefit of U.S. Provisional Patent Application No. 60/927,423, filed May 2, 2007. This application also claims the benefit of U.S. Provisional Patent Application No. 60/927,618, filed May 4, 2007. This application also claims the benefit of U.S. Provisional Patent Application No. 60/937,748, filed Jun. 28, 2007. Each of the priority applications are hereby incorporated by reference in their entirety.

### BACKGROUND

Financial institutions (FIs) such as banks and Credit Unions allow their customers to open accounts via a number of channels. For example, customers may walk into a branch, call into a call center, or open an account online. However, these channels are traditionally independent of each other. This independence causes various disadvantages and limitations.

One disadvantage is that FIs can not enforce a consistent set of decisioning rules (e.g. who is approved for a new account, who is declined, etc.). Since some applications will require follow up information (e.g. a request for a copy of a telephone bill), each channel requires its own back office staff to manage this follow-up. No cost benefits can be realized from sharing a team that performs management across all channels. Yet another disadvantage is that there is no consolidated reporting of applications and applicant data.

Another disadvantage is that it is traditionally difficult for FIs to offer applicants the ability to start an application in one channel (e.g. online) and switch to another channel (e.g. call center), even though applicants may want or need to do this. One of the reasons it is traditionally difficult for the FIs to provide such a multi-channel and cross channel capability is that multi-channel software and hardware must be built and maintained by the FI, or purchased by the FI. There is currently no platform that provides multiple FIs (even those too small to build their own systems) with a multi-channel and cross-channel capability in which requirements for different FIs can be added to the platform in a “plug-and-play” manner.

### BRIEF DESCRIPTION OF THE DRAWINGS

FIG. 1 is a series of diagrams illustrating cross-channel and multi-channel modes according to an embodiment.

FIG. 2 is a block diagram illustrating how different decisioning logic is used based on a channel in an embodiment.

FIG. 3 is a block diagram of a financial management system (FMS) according to an embodiment that performs multi-channel and cross-channel account opening.

FIG. 4 is a block diagram of an FMS in an embodiment.

FIG. 5 is a flow diagram illustrating a comparison of online account opening in which a user communicates with the FMS, and call center account opening, according to an embodiment.

FIG. 6 is a continuation of the diagram of FIG. 5.

FIG. 7 is a flow diagram illustrating a case in which the entire application process is handled by a call center of an FI, according to an embodiment.

FIG. 8 is a continuation of the diagram of FIG. 7.

FIG. 9 is a flow diagram illustrating a call center trial deposit process flow, according to an embodiment.

FIG. 10 is a flow diagram illustrating an application process that begins online and transfers to a call center.

FIG. 11 is a continuation of the diagram of FIG. 10.

FIG. 12 is a continuation of the diagram of FIGS. 10 and 11.

### DETAILED DESCRIPTION

Embodiments as described herein include methods and a system for multi-channel and cross-channel account opening. An applicant may start an account opening process in one channel and move to one or more other channels without any application data being lost. A financial management system (FMS) provides a single account opening platform for multiple financial institutions (FIs) such that an application to open an account is handled by the FMS platform using shared resources among channels, and applying rules specified by each FI. As used herein, an FI is a bank, credit union, brokerage firm or any other financial institution with which someone can open a financial account. The following are examples of different channels through which an applicant can apply (meaning apply to open a financial account). An applicant can apply via an FI's website. Alternatively, the web site may be operated and maintained by the FMS for the benefit of one or more FIs. An applicant can apply by calling the FI. An FI agent can talk to the applicant and fill out the application form on behalf of the applicant. An applicant can apply by walking into a FI branch office. An FI agent can talk to the applicant in person and fill out the application form on behalf of the applicant. Other examples of channels include kiosks and mobile channels.

An applicant can start an application in one channel, stop at any point and then continue in another channel. The FMS saves the application for the applicant. Each channel might have different business rules. For example different FIs can have different options and business processes for collecting a signature, different decisioning procedures, different instructions appearing on the screen (including what appears to the applicant when the applicant is online as opposed to what appears to an agent in a call center). Different FIs might also have different processes. The FMS intelligently handles these variations among channels and FIs. The system is able to offer different account options to applicants and collect different information from applicants in different channels (e.g. offering internet banking to applicants only on the online channel). Agents (FI representatives) either in the branch or in a call center are able to record notes during the application process. Different products can also be offered in different channels.

An embodiment uses the capability of OpenNow and FundNow (ONFN) technology (as provided by CashEdge, Inc.) and expands the capability into the Call Center and Branch channel to allow FI clients the opportunity to utilize the decisioning and finding aspects that exist online and thereby increase the application success rate. FI clients may also choose to combine all channel applications to be processed in one home ID in COMPASS™ (also provided by CashEdge, Inc.), and provide a consistent decisioning approach across multiple channels.

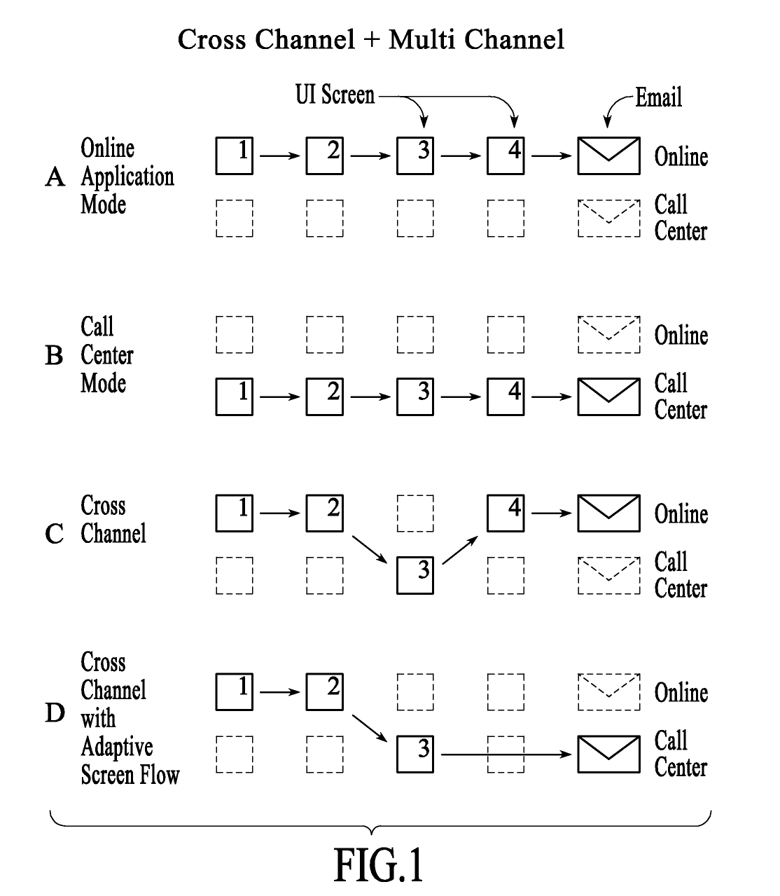

FIG. 1 is a series of diagrams illustrating cross-channel and multi-channel modes according to an embodiment. In online application mode A, an applicant (also referred to as a user or customer) progresses through screens 1-4 including logging in to a web site, performing identity verification (1 and 2), and interacting with a user interface (UI) as provided by the FMS. An email is sent at the end of the process to confirm the status of the application. The order in which particular screens appear is not fixed (for example, email could be in the middle of the series and not at the end). Some emails are channel-specific. For example, an online application has an associated email library specific to that channel. On the other hand, a call center email has content relevant to the call center. Other emails may be common across channels.

FIG. 1 is a simple example showing four screen screens, but typically there are more than fours screens. As indicated by the labels on the right of the diagram (“ONLINE” and “CALL CENTER”), the online application mode is parallel to a call center mode that is not used in A.

Call center mode B is similar to mode A, except that the user interacts with the call center and not a web site. In cross channel mode C, the user begins the account application process online, but at step 3, calls into a call center (for assistance, for example), talks to a person at the call center who is able to view the application in real time, help the applicant with a screen, and then the applicant transitions back to online mode to complete the application.

In cross channel with adaptive screen flow mode D, the user begins in online mode and then transitions to the call center. In this case the application process is completed at the call center. The flow is adaptive in that the FMS “skips” or does not present screens that are not relevant to a particular channel. In D, screen four is skipped, and can be for example a signature screen that is not applicable in the call center channel.

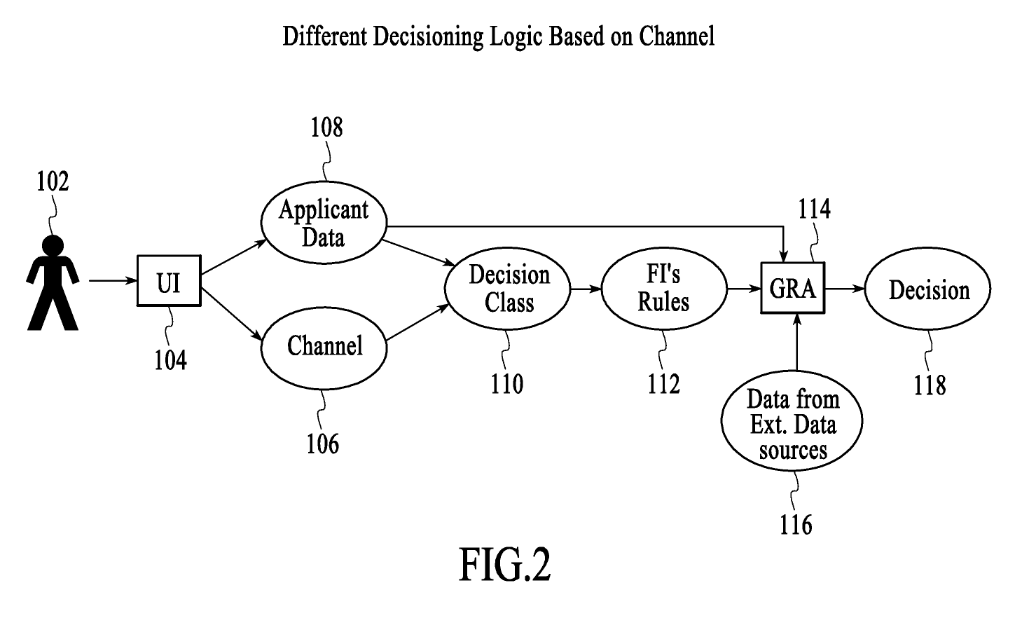

FIG. 2 is a block diagram illustrating how different decisioning logic is used based on a channel. A user 102 accesses a UI 104 for beginning an account opening process. Applicant data 108 supplied by the user and the channel that the applicant is in currently 106, are used as inputs with which the FMS chooses which decision class 110 to use. The decision class then dictates the actual rules 112 that are used to make a decision on the application. A global risk administration (GRA) module 114 receives applicant data 108 and data 116 extracted from external sources (such as credit bureaus, debit bureaus, public records, proprietary FI information, etc.) and process this data against the FI's specific rules for this type of applicant and the active channel 112. GRA module 114 outputs a decision 118 regarding whether or not to approve the application.

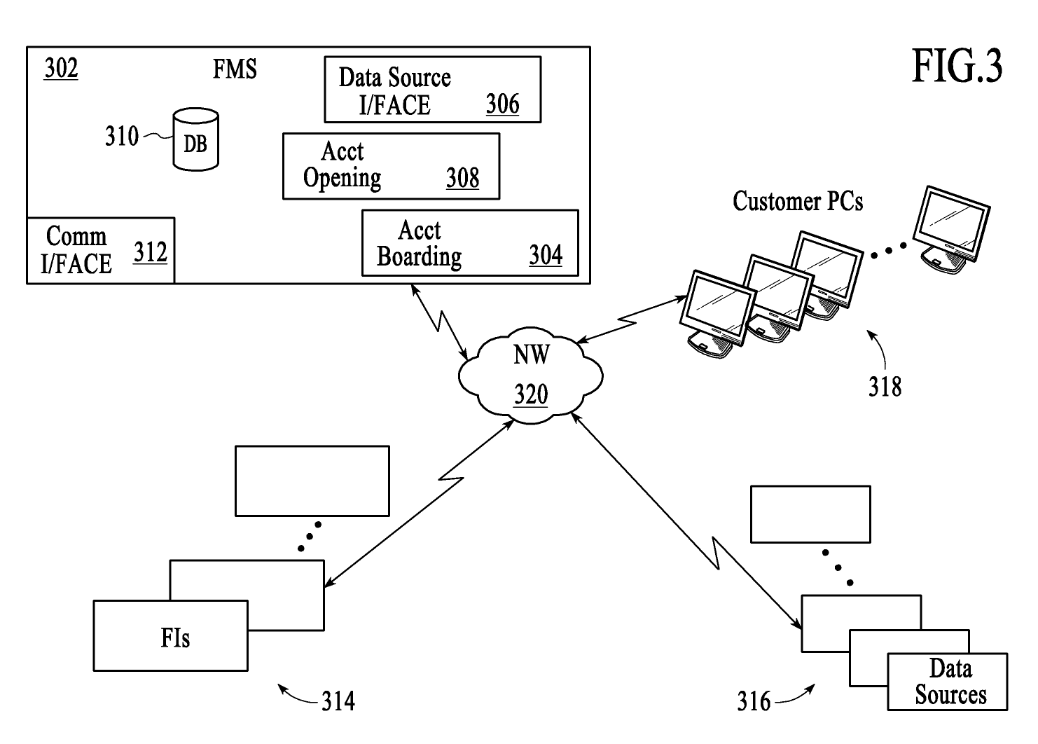

FIG. 3 is a block diagram of a financial management system (FMS) 302 according to an embodiment that performs multi-channel and cross-channel account opening. The FMS 302 communicates with a network 320. Network 320 is typically the Internet, but can be any communications network including a local area network (LAN), wide area network (WAN), etc. The FMS communicates with multiple financial institutions (FIs) 314 to provide account opening services (among other services) using account opening module 308 and account boarding module 304. Account boarding in an embodiment includes real-time integration with an FI core system such that new accounts can be opened in real-time and all of the necessary account information can be “boarded” to the FI core by the account boarding module. Real-time core integration is further described in copending U.S. patent application Ser. No. 12/111,012, filed Apr. 28, 2008, which is incorporated herein in its entirety. In addition, a data source interface 306 of the FMS 302 communicates with multiple data sources 316. For example, the data source interface 306 is used by the FMS 314 to provide verification of user identity, risk management functions, etc. FMS 302 further communicates with multiple customers (also referred to as users) personal computers (PCs). Database 310 maintains various types of data, including settings or preferences for particular FIs, applicant data, and channel-specific data as further described below.

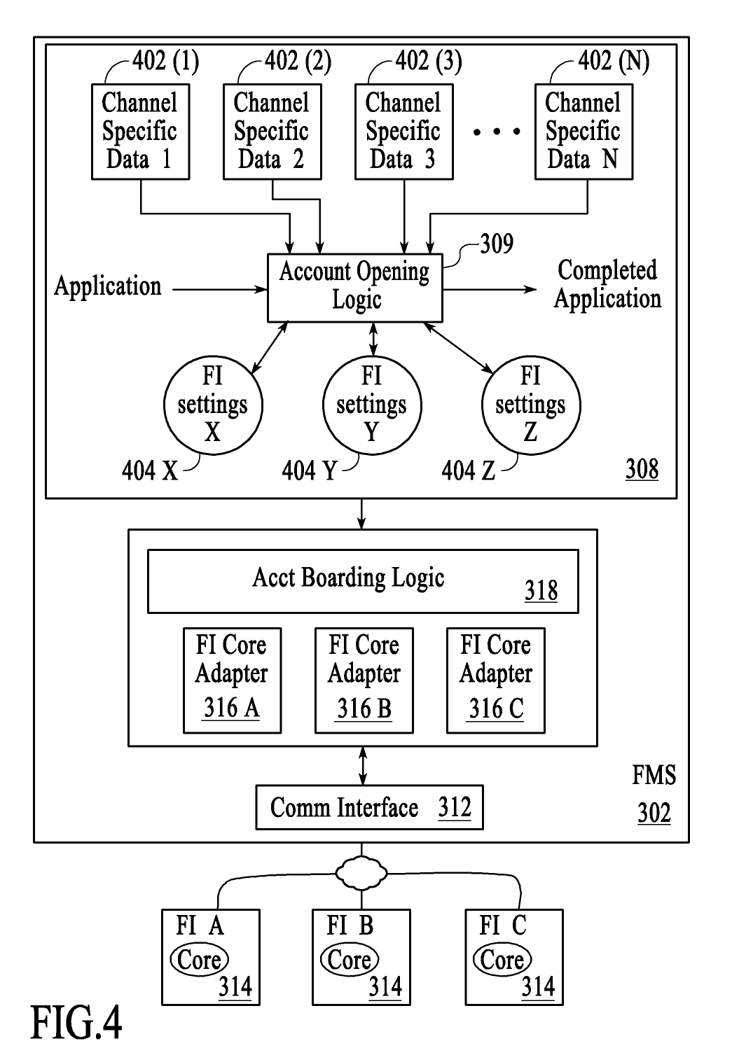

FIG. 4 is a block diagram of an FMS 302 in an embodiment. The FMS 302, as previously described, includes the account opening module 308, the account boarding module 304, and the communications interface 312. Three FIs (FI A, FI B and FI C) are shown as an example. Typically more than three FIs communicate with the FMS 302, but the number can be one or more than one. Each of FIs 314 has a respective core system. FIs employ these core systems to function as account opening systems and maintain customer and account data, including new account information (account number assignment for example). Typically these cores are “black box” solutions that are built or purchased by FIs. An example is the MISER suite of software applications available from Fidelity. MISER is built around a single, integrated database containing customer, account, and financial information, with open connectivity to ancillary systems through extensible markup language (XML) and application programming interfaces (APIs). MISER is available from Fidelity, as is IMPACS, another cores system. Other examples of core systems include VISIONS AND CBS (available from FiServ), and HOGAN (available from CSC Industries). FI core adapters 316A, 316B, and 316C are able to communicate with each respective FI core in order, for example to perform account boarding using account boarding logic 318, in the protocol required by the core system.

Account opening module 308 includes account opening logic 309 which receives and processes applications for opening financial accounts, and outputs completed applications, or application approvals. The account opening logic 309 is a shared resource in the sense that applications are received via multiple channels (as previously described, such as online, in person in a branch, etc.), yet the account opening logic is shared across all of the channels. One consequence is that data from an application is retained across channels. Channel specific data 402(1), 402(2), and 402(3) are examples of data specific to each channel that can be “plugged into” the account opening logic, which operates on it as necessary. Examples of data specific to a call center channel include: no signature card available for the call center channel, rather support a mailed signature card to be receive from the applicant and processed in the call center; no real-time account verification, etc.

Each FI further has settings (for example 404X, 404Y and 404Z) that are also plugged into the account opening logic 309. In an embodiment, specific FI's may change FI setting 404X, 404Y or 404Z by simply providing an input to the account opening logic 309 via a software switch mechanism. In an embodiment, the FI settings 404 include preferences and rules for approving applications. For example, different FIs may choose different milestones to be met before an account can be opened. Each FI may opt to have access to any number of channels to offer its customers. Each FI can have different rules for each channel it opts to offer.

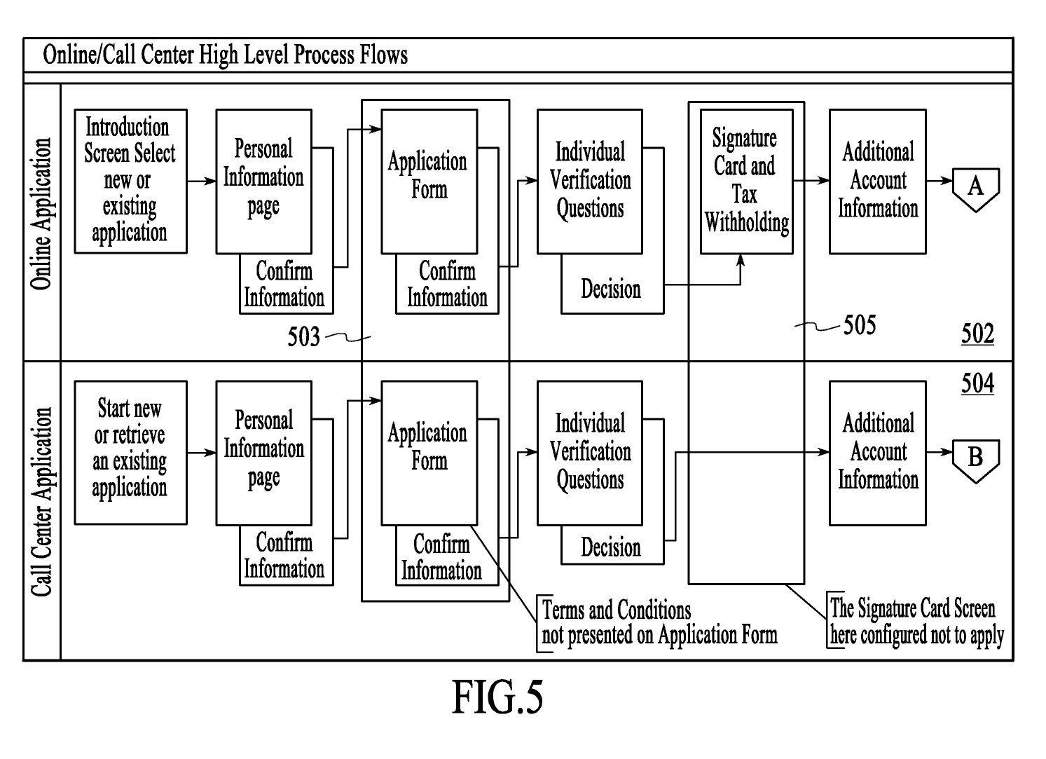

FIG. 5 is a flow diagram illustrating a comparison of online account opening 502 in which a user communicates with the FMS, and call center account opening 504 in which a call center representative of an FI communicates with the FMS while talking to the customer. Referring to 502, the online user views an introduction screen and selects “new” or “existing” application. Personal information is displayed to the user and the user is asked to confirm the information. The user then views the application form, fills in the application form, and confirms the information. The user is then presented with individual verification questions, and a decision is made whether or not to approve the application. If the application is approved, a signature card is presented to the user, and any addition account information is given to the user.

As a comparison to the online flow 502, the call center flow 504 differs in aspects as indicated by 503 and 505. At 503, the application form is visible to the call center representative who converses with the customer to fill in the form. However, the terms and conditions are not presented on the application form in the call center case. Because terms and conditions (T&Cs) need to be “seen” by the applicant and the applicant needs to have the ability to save them, they are not presented in the call center case, rather the FI agent mails a packet with the T&Cs to the applicant.

At 505, for the call center case, the signature card screen does not apply, as the call center agent rather than the customer is viewing the screen. An e-signature can not be accepted from the applicant over the phone, so the agent typically mails a signature card to the applicant.

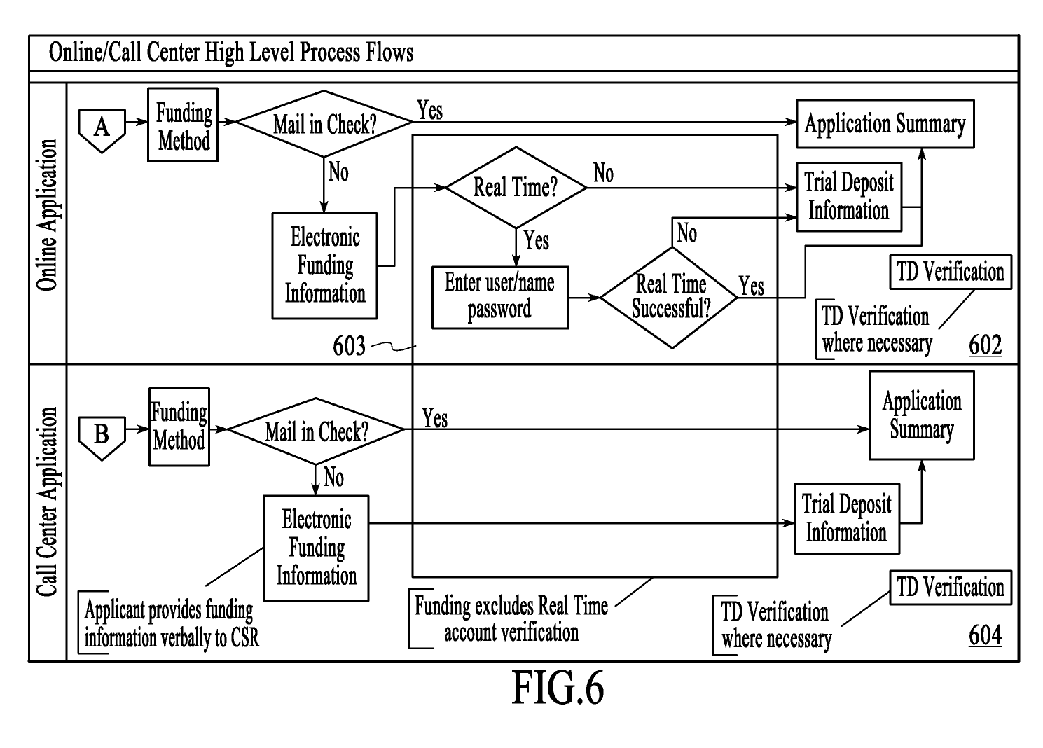

FIG. 6 is continuation of the diagram of FIG. 5. Referring to flow 602, a funding method can be selected by the customer, and the customer is given the option to mail in a check for funding the new account. If the customer opts to mail in a check, an application summary is presented. Alternatively, the customer may choose to provide electronic funding information in order to fund the new account electronically, including in real-time online. If the customer selects the option to provide electronic funding information, details of the funding are collected from the customer. The applicant's ownership of the funding account can be verified by: 1) checking information supplied by the applicant against stored information; 2) real-time verification in which the applicant provides account access credentials during the online session, and the FMS uses the credentials to attempt to access the account immediately; and 3) trial deposits, according to which the FMS places two random amounts in the applicant-specified funding account and then asks applicant what the amounts are. If the applicant opts to verify funding account information in real-time, a user name and password is requested. If this real-time verification is successful, an application summary is presented, otherwise the FMS reverts to the trial deposit method.

If the customer selects electronic funding and does not use the real-time verification method, the FMS initiates the trial deposit method. Once the trial deposit method is initiated, the application summary is presented.

Referring to the call center flow 604, the call center agent views the screens presented by the user interface instead of the customer, as is the case in the flow 602. The flows 602 and 604 differ in the following aspects: the applicant provides funding information verbally to the agent instead of entering the information; as shown at 603, and real-time account verification is not available in the call center flow as it is in the online application flow. Although real-time account verification could be available on the call center, it is not secure for the applicant because personal information would have to be given directly to an agent, rather than entered online by the applicant.

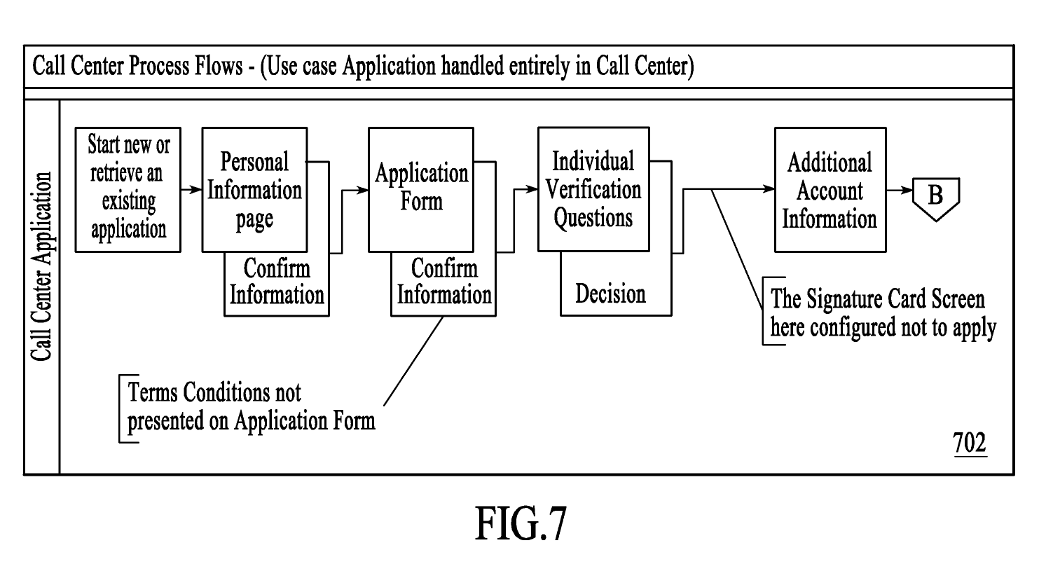

FIG. 7 is a flow diagram illustrating a case in which the entire application process is handled by a call center of an FI (such as an FI 314 of FIG. 3) interacting with a customer via the telephone, and interacting with the FMS 302 via a network 320. The call center, upon receiving a call from a customer regarding an application, can start a new application, or alternatively, retrieve an existing application. This is because, as shown and described with reference to the previous figures, the application information is retained by the FMS 302 regardless of the channel through which a customer or applicant originally began an application. In the case of an existing application, the call center agent picks up the application at whatever point the applicant left off, and continues to complete the application while conversing with the applicant.

On receiving a call from a customer, for a new application, the agent can view and fill-in a personal information page. When the application form is complete, the agent can verbally confirm the information on the application. However, in an embodiment, the terms and conditions of the application are not presented on the application form in the call center case for the reasons stated above.

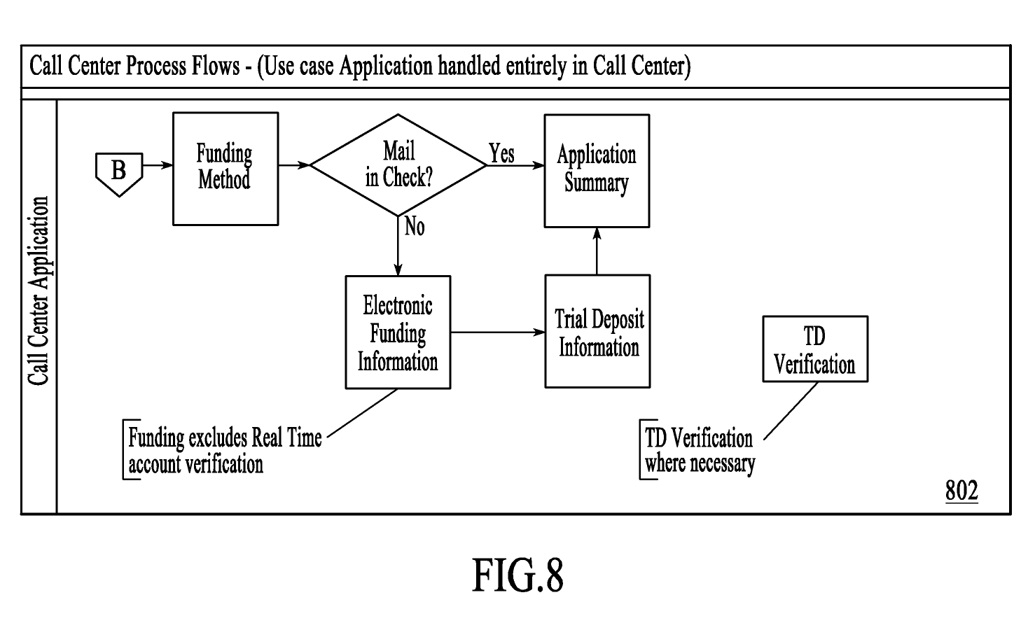

The agent at this point may present individual verification questions to the customer. The FMS makes the decision whether to approve the application based on the information provided to the FMS by the agent. A different message can be shown to the agent than to the applicant even for the same decision. For example, in the online channel the applicant may see a decline message. However, over the phone, using the call center channel, it may not be desirable to tell the applicant that they are declined, because they may get into a confrontation with the agent. In contrast to online application flows, a signature card screen is not configured to appear at this point in the flow. Pending additional account information, which may or may not be required depending upon the business rules of the FI, the application proceeds as shown in FIG. 8. A funding method is selected by the customer. The customer may choose to mail in a check to fund the new account. If the customer opts to mail in a check, an application summary is presented to the agent. If the customer does not opt to mail in a check, electronic funding information is required of the customer. In an embodiment, this type of funding typically excludes real-time account verification for the security reasons previously explained.

When electronic funding information is not provided (in this case in which real-time funding account verification is excluded), the trial deposit process is initiated by the FMS. If the trial deposit information is successfully received from the applicant, an application summary is presented to the agent.

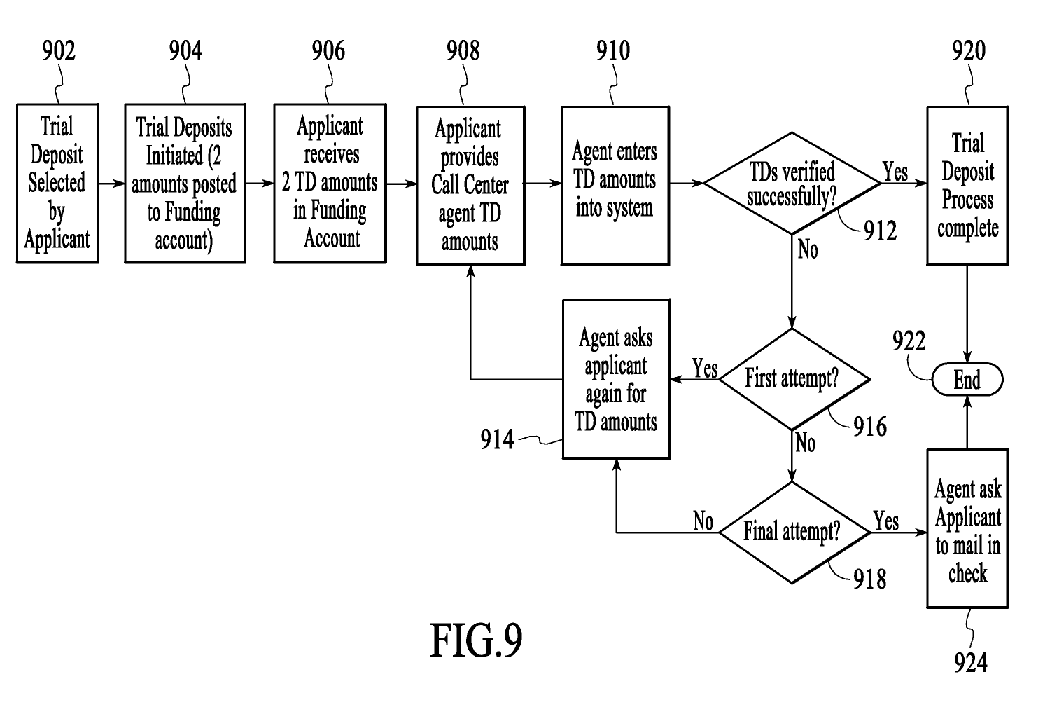

FIG. 9 is a flow diagram illustrating a call center trial deposit process flow. At 902, a trial deposit is chosen by the applicant, or customer. For trial deposits, two amounts are posted to the funding account at 904. The applicant receives the two trial deposit amounts in the funding account at 906 and then provides the call center representative (also referred as agent) with the amounts at 908. The agent enters the trial amounts into the system at 910. The FMS determines whether the trial deposits are successfully verified at 912. If the trial deposits are not successfully verified, it is determined at 916 whether it is the first attempt to verify trial amounts. If it is the first attempt, the agent again asks for the trial amount again at 914 and the process returns to 908. If it is the first attempt, it is determined whether it is the final attempt at 918 based on a predetermined allowed number of attempts (per the FI settings 404 of FIG. 4, for example). If it is not the final attempt, the agent again asks for the trial amount at 914 and the process returns to 908. If it is the final attempt, the agent asks the applicant to mail in a check at 924. If at 912, the trial amount is successfully verified, the trial deposit process is complete at 920 and the trial deposit verification process ends at 922.

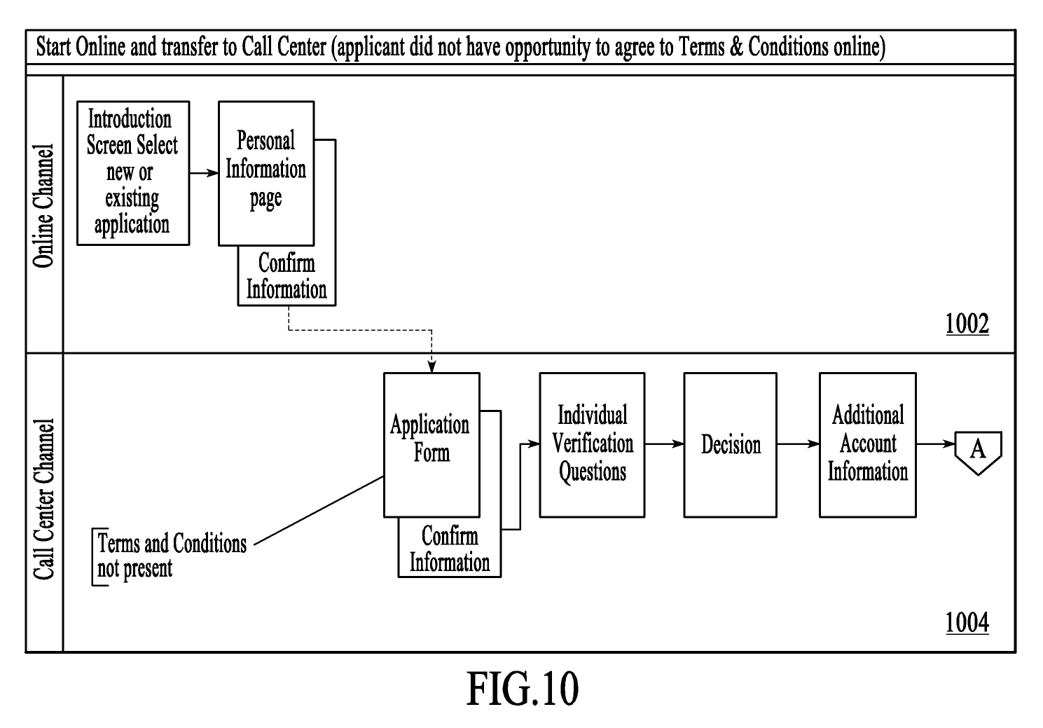

FIGS. 10, 11, and 12 illustrate the case when the applicant can not accept the T&Cs in the call center channel over the phone, and can not provide a signature over the phone. The applicant can instead wait for a packet with T&Cs to arrive, sign where necessary and return the packet. Alternatively, the applicant can go online, accept the T&Cs online, and provide an e-signature.

FIG. 10 is a flow diagram illustrating an application process that begins online and transfers to a call center. For example FIG. 10 illustrates a case in which the applicant has not yet agreed to terms and conditions online. The online channel flow is indicted by 1002, while the call center channel flow is indicated by 1004. Referring first to 1002, an introduction screen invited the applicant to select a new application of an existing application (whose information is stored by the FMS as previously described). A personal information page is used to collect some high-level personal information from the applicant upon the applicant choosing a new or existing application, and the applicant is asked to verify or confirm information. If for some reason the applicant does not complete confirming the information (for example agreeing to the terms and conditions) the applicant may change channels to a call center. Referring to 1004, a call center representative sees the application form, but not necessarily terms and conditions. The representative can verbally confirm information with the applicant and conduct individual verification questions. The FMS makes the decision whether to approve the application and the agent informs the applicant of the decision.

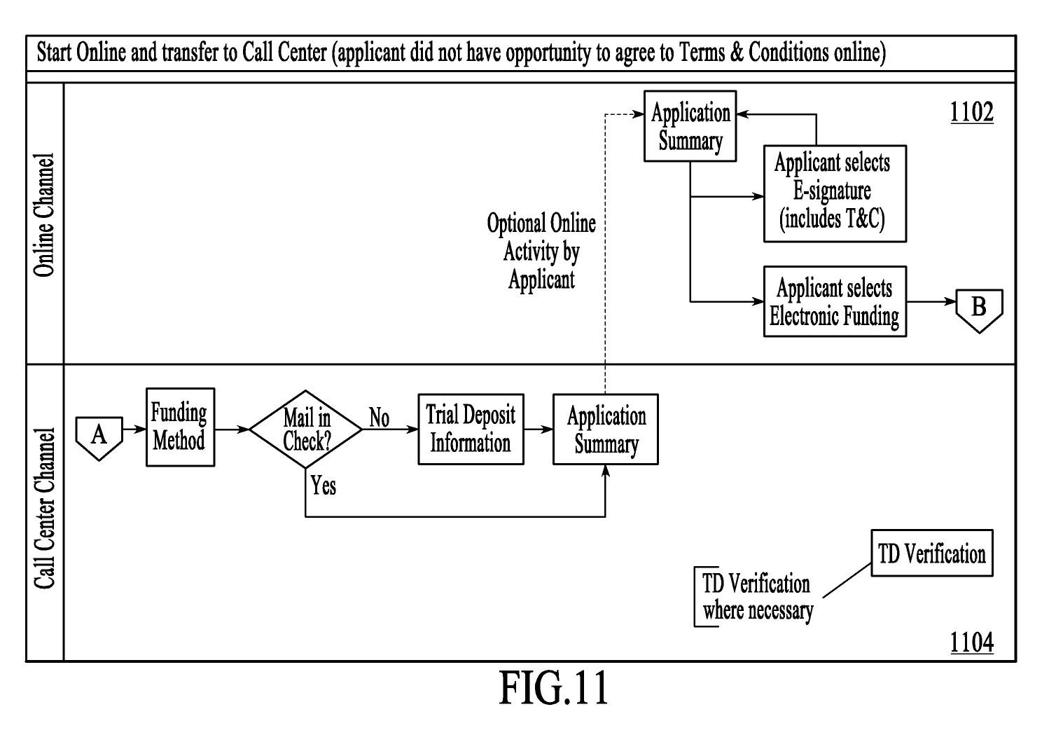

Continuing the process in FIG. 11, referring to 1104, the call center representative with the applicant determines the funding method for the new account. For example, the applicant may mail in a check. If the applicant chooses not to mail in a check, funding account information is requested, and the trial deposit method of verifying the account is initiated. In either of these cases, an application summary is then generated by the FMS and presented to the call center agent.

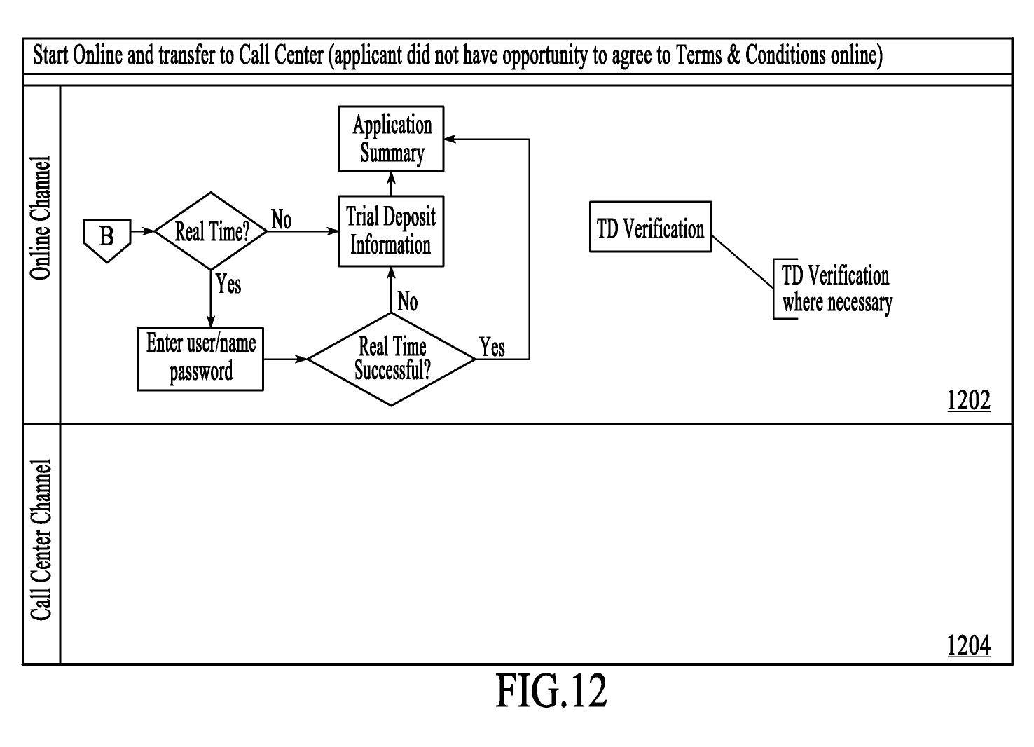

Referring to 1102, optional online activity by the applicant includes the applicant signing any outstanding terms and conditions (T&Cs) and viewing and viewing an application summary. After viewing the application summary, the applicant may select an electronic signature. The applicant may also choose electronic funding as further described with reference to “B” in FIG. 12.

FIG. 12 is a flow diagram that continues the flow of FIGS. 10 and 11. FIG. 12 illustrates a case in which a user or applicant began an application process online, and then transferred to a call center.

As shown by reference letter B, the process of 1102 continues the online channel electronic funding of the new account using a real-time funding account verification process. If the funding account verification uses the real-time process, the applicant enters a user name and password related to the funding account. If the real-time verification is successful, an application summary is presented to the applicant. If the real-time access is not successful, the FMS may initiate the trial deposit method before the application summary is presented to the applicant.

What is claimed is:

1. A method for multi-channel financial account opening, the method comprising:
an applicant initiating an account opening process in a first channel of multiple channels, wherein channels comprise,
an online channel wherein the applicant accesses an electronic application to open an account at one of a plurality of financial institutions (FIs) via a network;
a call center channel wherein the applicant converses with a call center agent of the FI, and wherein the agent accesses an electronic application to open an account at the FI via a network;
a kiosk channel wherein the applicant accesses an electronic application to open an account at one of a plurality of financial institutions (FIs) via a network using a kiosk;
a walkin channel wherein the applicant enters an FI facility and converses in person with an agent of the FI, and wherein the agent accesses an electronic application to open an account at the FI via a network;
a mobile channel wherein the applicant accesses an electronic application to open an account at one of a plurality of financial institutions (FIs) via a network using a mobile device; and
wherein the electronic application is maintained by a financial management system (FMS) that provides account opening services to each of the plurality of FIs using rules specified by each FI, and using shared account opening resources;
the applicant changing from one channel to another channel, wherein any information collected after initiation of the process is saved by the FMS and made available in any of the channels.

2. A financial management system, comprising:
a communications interface configurable to communicate with a plurality of financial institutions (FIs) and with a plurality of applicants via at least one network, wherein the applicants are applicants for financial accounts at one of the FIs;
a database configurable to store data regarding the FIs and data regarding the applicants; and
an account opening module configurable to perform account opening services for each of the plurality of FIs, the account opening module comprising,
account opening logic configurable to complete an account opening process;
a plurality if channel specific data modules are each specific to a channel, and each plugged into the account opening logic, wherein a channel specific data module determines behavior of the account opening logic as appropriate to a particular channel; and
a plurality of FI settings each specific to an FI, and each plugged into the account opening logic, wherein FI determines behavior of the account opening logic as appropriate to a particular FI, and wherein one or more channel data modules are associated with each FI setting.
